(19) United States
(12) Patent Application Publication
(10) Pub. No.: US 2007/0178978 A1
(43) Pub. Date: Aug. 2, 2007

(54) CLAMPLESS STEERING GEAR BELLOW FOR AUTOMATED ASSEMBLY

(76) Inventor: Robert Boutin, Northville, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/668,126

(22) Filed: Jan. 29, 2007

Related U.S. Application Data
(60) Provisional application No. 60/762,696, filed on Jan. 27, 2006.

(51) Int. Cl. F16D 3/84

(52) U.S. Cl. 464/175

(57) ABSTRACT

A bellow assembly covers portions of a tie rod and a steering gear housing of an automotive vehicle. The bellow assembly includes a first ring and a bellow. The first ring has a cylindrical portion formed to be press fit onto the tie rod. The bellow has an outer end axially retained by the first ring for coupling the bellow to the tie rod. The outer end of the bellow is rotatable relative to the first ring to facilitate an alignment of vehicle wheels.

### REFERENCE TO RELATED APPLICATIONS

This application claims priority to U.S. provisional patent application No. 60/762,696, which was filed Jan. 27, 2006 and is incorporated herein by reference in its entirety.

### FIELD OF THE INVENTION

The invention relates to a flexible boot or bellow that covers the joint between a tie rod and a steering gear housing of a vehicle. More particularly, the invention relates to a bellow that is adapted for automated assembly of the bellow to the vehicle.

### BACKGROUND OF THE INVENTION

In vehicles a flexible boot or bellow is used to cover the joint between a tie rod and a hub of the steering gear. The bellow is provided to prevent corrosion of the rack and subsequent leaking. The inner tie rod must be allowed to rotate freely relative to the bellow in order to allow workers in the vehicle assembly plant to set the toe or front-end alignment. The bellow is attached to the steering gear by sliding an end of the bellow over a locating groove on the steering housing and tightening a clamp over the bellow and housing. The opposite end of the bellow is positioned over a locating groove on the inner tie rod and attached with a spring clamp. The spring clamp secures the bellow to the locating groove to prevent axial dislocation and allows for rotation without excessive torque.

The bellow must be manually assembled due to difficulty in positioning the bellow properly in the groove of the housing and the locating groove on the inner tie rod as well as positioning and clamping the ends of tie bellow. Because of the manual aspect of the positioning and clamping of the parts, there are a number of quality concerns related to the operation including improper clamping, missing clamps and damaged bellows. Accordingly, it would be desirable to provide an automated method of assembly and apparatus, which can ensure that the bellow is positioned and installed properly.

### SUMMARY OF THE INVENTION

According to one aspect of the invention, a bellow assembly is provided for covering portions of a tie rod and a steering gear housing of a vehicle. The bellow assembly includes a first ring and a bellow. The first ring is formed for press fitting onto the tie rod. The bellow has an outer end axially retained by the first ring for coupling the bellow to the tie rod. The outer end of the bellow is rotatable relative to the first ring to facilitate an alignment of vehicle wheels.

According to another aspect of the invention, a steering assembly is provided that includes a tie rod, a steering gear housing and a bellow assembly. The bellow assembly includes a first ring, a second ring and a bellow. The first ring is formed for press fitting onto the tie rod. The second ring is formed for press fitting onto the steering gear housing. The bellow has an inner end and an opposite outer end. The inner end is axially and rotatably constrained by the second ring for securing the bellow to the steering gear housing. The outer end is axially retained by the first ring for coupling the bellow to the tie rod. The outer end further is rotatable relative to the first ring to facilitate an alignment of vehicle wheels.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a cross sectional of a bellow assembly, a tie rod and a steering gear housing, with the bellow shown cutaway to show the tie rod and steering gear housing.

FIG. 2 is an enlarged cross sectional view of an outer end of the bellow assembly and tie rod; and

FIG. 3 is an enlarged cross sectional view of an inner end of the bellow assembly and steering gear housing.

### DETAILED DESCRIPTION OF THE PREFERRED EMBODIMENTS

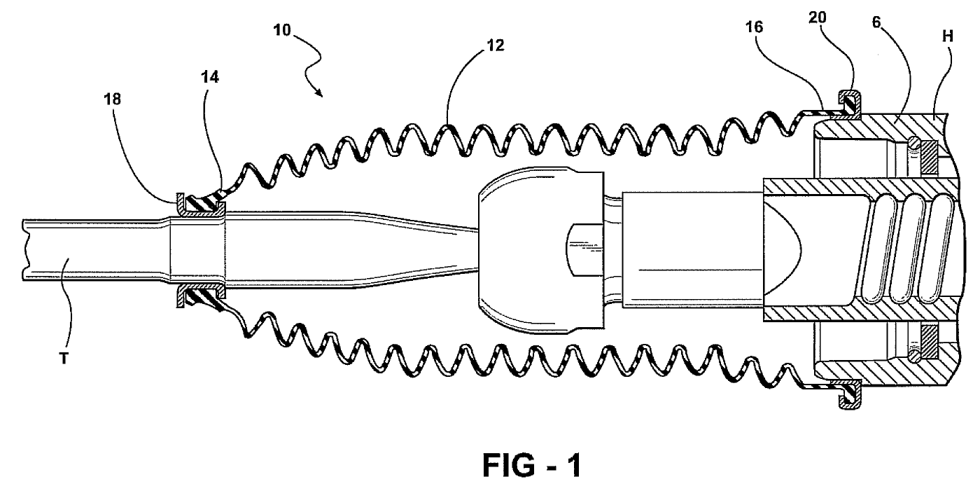

Referring to FIG. 1, a steering boot or bellow assembly is generally indicated at 10. The bellow assembly 10 is designed to allow installation between a tie rod T and a steering gear housing H of a vehicle without the use of clamps. The bellow assembly 10 includes a bellow 12, a first ring 18, and a second ring 20.

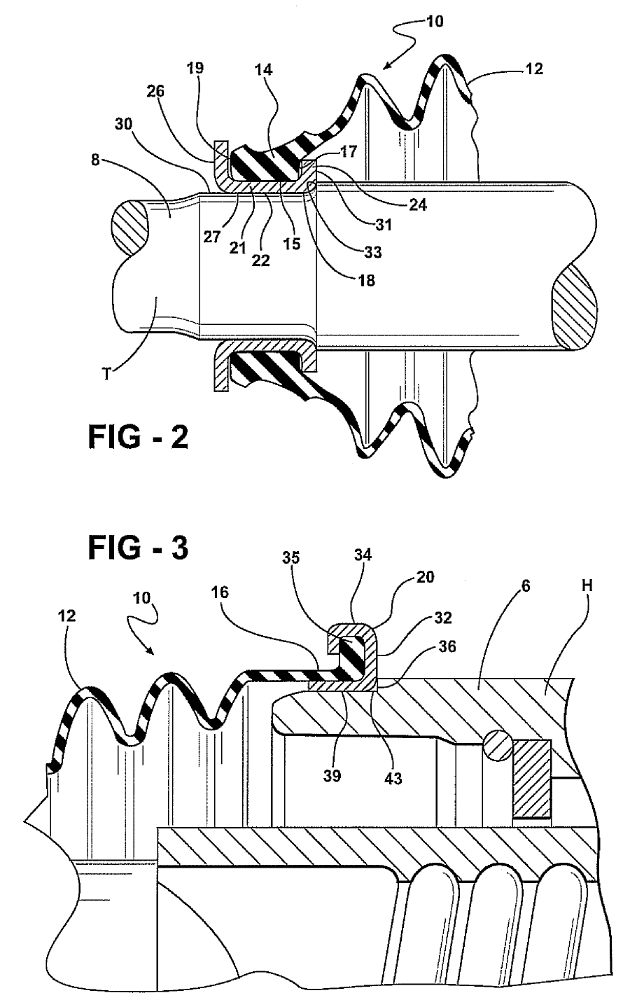

Referring to FIG. 2, the bellow 12 has an annular shaped outer end 14 that is axially retained and rotatably coupled to the first ring 18. More specifically, the outer end 14 has a generally cylindrical inner surface 15 that extends between radially extending end surfaces 17, 19. The first ring 18 has a cylindrical portion 21 and a pair of lips 24, 26 extending outwardly from opposite ends of the cylindrical portion 21. The end surfaces 17, 19 are received axially between the lips 24, 26 of the first ring 18. The inner surface 15 of the outer end 14 extends over the cylindrical portion 21 of the first ring 18, such that the outer end 14 of the bellow 12 is rotatable relative to the first ring 18. A lubricant, such as grease, may be provided between the inner surface 15 and the cylindrical portion 21 to minimize friction between the outer end 14 and the first ring 18. Optionally, an annular groove may be provided along the inner surface to receive the lubricant therein.

The first ring 18 has a first annular surface 27 that is formed to be press fit onto an outer cylindrical surface 30 of the tie rod T. The first ring 18 also has a radially extending end surface 31 that abuts a locating edge 33 on the tie rod T to axially locate the outer end 14 of the bellow 12 relative to the housing H. The first ring 18 may be formed of metal, plastic or other suitable materials known by those having ordinary skill in the art. Optionally, the intersection between the locating edge 33 and the outer cylindrical surface 30 has a radius to match an outer corner or radius between the cylindrical portion 21 and inner lip 24 of the first ring 18 to allow precise positioning between the first ring 18 and the tie rod T and to provide a seal therebetween.

Referring to FIG. 3, the inner end 16 of the bellow 12 has a radially extending flange 35. The flange 35 extends into a generally U-shaped retaining portion 34 formed on the second ring 20. The second ring 20 may be formed from plastic and molded over the flange 35. The second ring 20 may also be formed from metal, wherein the retaining portion 34 extends over and is crimped onto the flange 35 for securing the second ring 20 to the bellow 12.

The second ring 20 has a second annular surface 39 that is formed to be press fit onto an outer cylindrical surface 43 of the housing H. Optionally, at least one inwardly extending protrusion, such as a tooth or a step, may be formed along the second annular surface to ensure a tight interference fit between the second ring and the housing. The second ring 20 also has a radially extending inner end surface 32 that abuts a radially extending locating step 36 on the housing H to axially locate the inner end 16 of the bellow 12 relative to the housing H.

The bellow assembly 10 may be installed on the vehicle using an automated operation. The bellow assembly 10 is first placed in a holding fixture, which positions the bellow assembly 10 in a generally coaxial orientation over the housing H and the tie rod T. In a first step, the first ring 18 is pressed onto the tie rod T and retained thereon by the interference fit between the first annular surface 27 and the outer cylindrical surface 30 of the tie rod T. The end surface 31 abuts the locating edge 33 to axially locate the outer end 14 of the bellow 12 relative to the tie rod T. In the second step, the second ring 20 is pressed onto the housing H and retained thereon by the interference fit between the second annular surface 39 and the outer cylindrical surface 43 of the housing H. The inner end surface 32 abuts the locating step 36 to axially locate the inner end 16 of the bellow 12 relative to the housing H.

In use, the first ring 18 is tightly fixed to the tie rod T and the second ring 20 remains fixed to the housing H without the need for clamps. The outer end 14 of the bellow 12, however, remains rotatable with respect to the first ring 18, thereby permitting rotation of the bellow 12 relative to the tie rod T to facilitate alignment of the vehicle wheels.

Thus, a bellow assembly has been disclosed with ends that can be secured to a tie rod and a steering gear housing of a vehicle without clamps. The ends may be press fit onto the tie rod and the steering gear housing to allow or facilitate automatic assembly of the bellow to the vehicle.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

I claim:

1. A bellow assembly for covering portions of a tie rod and a steering gear housing of a vehicle, said bellow assembly comprising:
a first ring formed for press fitting onto the tie rod;
a bellow having an outer end axially retained by the first ring for coupling the bellow to the tie rod, the outer end of the bellow being rotatable relative to the first ring to facilitate an alignment of vehicle wheels.

2. A bellow assembly as set forth in claim 1, wherein the outer end of the bellow has a generally cylindrical inner surface rotatably coupled to the first ring.

3. A bellow assembly as set forth in claim 2, wherein the outer end of the bellow includes radially extending end surfaces disposed on opposite ends of the inner surface.

4. A bellow assembly as set forth in claim 3, wherein the first ring includes a cylindrical portion and a pair of lips extending outwardly from opposite sides of the cylindrical portion, the lips being axially spaced apart to receive the end surfaces of the bellow therebetween.

5. A bellow assembly as set forth in claim 4, wherein the inner surface of the outer end is rotatably coupled to the cylindrical portion of the first ring with lubricant being disposed therebetween.

6. A bellow assembly as set forth in claim 1 including a second ring formed for press fitting onto an outer cylindrical surface of the steering gear housing, the second ring having a retaining portion that retains an inner end of the bellow for securing the bellow to the steering gear housing.

7. A bellow assembly as set forth in claim 6, wherein the bellow includes an outwardly extending flange that is retained by the retaining portion of the second ring.

8. A bellow assembly as set forth in claim 7, wherein the second ring is plastic and is molded over the outwardly extending flange of the bellow.

9. A bellow assembly as set forth in claim 7, wherein the second ring is metal and the retaining portion is crimped over the outwardly extending flange to secure the second ring to the bellow.

10. A bellow assembly as set forth in claim 7, wherein the second ring includes at least one inwardly extending protrusion providing interference between the second ring and the steering gear housing.

11. A steering assembly comprising:
a tie rod;
a steering gear housing; and
a bellow assembly having:
a first ring formed for press fitting onto the tie rod;
a second ring formed for press fitting onto the steering gear housing;
a bellow having an inner end and an opposite outer end, the inner end being axially and rotatably constrained by the second ring for securing the bellow to the steering gear housing, the outer end being axially retained by the first ring for coupling the bellow to the tie rod, the outer end further being rotatable relative to the first ring to facilitate an alignment of vehicle wheels.

12. A steering assembly as set forth in claim 11, wherein the outer end of the bellow has a generally cylindrical inner surface rotatably coupled to the first ring.

13. A steering assembly as set forth in claim 12, wherein the outer end of the bellow includes radially extending end surfaces disposed on opposite ends of the inner surface.

14. A steering assembly as set forth in claim 13, wherein the first ring includes a pair of radially extending lips that is spaced apart to receive the end surfaces of the bellow therebetween.

15. A steering assembly as set forth in claim 12 including a lubricant disposed between the inner surface and the first ring to reduce friction therebetween.

16. A steering assembly as set forth in claim 11, wherein the second ring is formed for press fitting onto an outer cylindrical surface of the steering gear housing, the second ring having a retaining portion that retains the inner end of the bellow and secures the bellow to the steering gear housing.

17. A steering assembly as set forth in claim 16, wherein the bellow includes an outwardly extending flange that is retained by the retaining portion of the second ring.

18. A steering assembly as set forth in claim 17, wherein the second ring is plastic and is molded over the outwardly extending flange of the bellow.

19. A steering assembly as set forth in claim 17, wherein the second ring is metal and the retaining portion is crimped over the outwardly extending flange to secure the second ring to the bellow.

20. A steering assembly as set forth in claim 19, wherein the second ring includes at least one inwardly extending protrusion providing interference between the second ring and the steering gear housing.
